(19) United States
(12) Patent Application Publication
(10) Pub. No.: US 2009/0245439 A1
(43) Pub. Date: Oct. 1, 2009

(54) Output Buffer In The Presence Of Multiple Power Supplies

(75) Inventors: Anant Shankar Kamath, Bangalore (IN); Jagdish Chand Goyal, Bangalore (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/058,773

(22) Filed: Mar. 31, 2008

(51) Int. Cl. H04B 7/00; H04B 1/06

(52) U.S. Cl. 375/345; 455/230

(57) ABSTRACT

An output buffer providing a buffered output signal using multiple power supplies. The output signal is driven using a first power supply during a first interval, and using another (second) power supply during a second interval. In an embodiment, the first power supply is designed to be a high capacity supply, and drives the output signal during a substantial portion of a logic 0 to logic 1 transition. The second power supply is designed to be a low capacity supply, and drives the output during steady states (logic 0/logic 1).

### BACKGROUND

1. Field of the Technical Disclosure

The present disclosure relates generally to output buffers, and more specifically to output buffers operated using multiple power supplies.

2. Related Art

Output buffers are often used in integrated circuits to drive external device(s)/component(s) (e.g., another integrated circuit) based on data received from another source (usually from another part of the integrated circuit in which the buffer is implemented). The driven external device(s)/component(s) is hereafter referred to as external load.

In general, output buffers need to drive external loads with sufficient strength (e.g., the amount of current) to ensure that the data is accurately transferred to the external devices within a pre-specified time duration.

An output buffer generally requires a power supply at least to drive an external load. It is generally desirable that such power supply be provided using various resources as available in and/or as suited for the environment in which the output buffer is implemented.

### BRIEF DESCRIPTION OF THE DRAWINGS

The present invention will be described with reference to the following accompanying drawings, which are described briefly below.

FIG. 1 is a block diagram of an example prior environment which can be extended/modified according to several features of the present invention.

FIG. 2 is a flowchart illustrating the manner in which an output of an output buffer is generated using multiple power supplies in an embodiment of the present invention.

FIG. 3 is a diagram of an integrated circuit containing an output buffer operated using two power supplies, in an embodiment of the present invention.

FIG. 4 is timing diagram illustrating the manner in which the output of an output buffer is be driven by different power supplies in different time intervals.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

An output buffer provided according to an aspect of the present invention provides a buffered output signal using multiple power supplies. The output signal is driven using a first power supply during a first interval, and using another (second) power supply during a second interval. In an embodiment, the first power supply is designed to be a high capacity supply, and drives the output signal during a substantial portion of a logic 0 to logic 1 transition. The second power supply is designed to be a low capacity supply, and drives the output during steady states (logic 0/logic 1).

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well known structures or operations are not shown in detail to avoid obscuring the features of the invention.

### 2. Example Environment

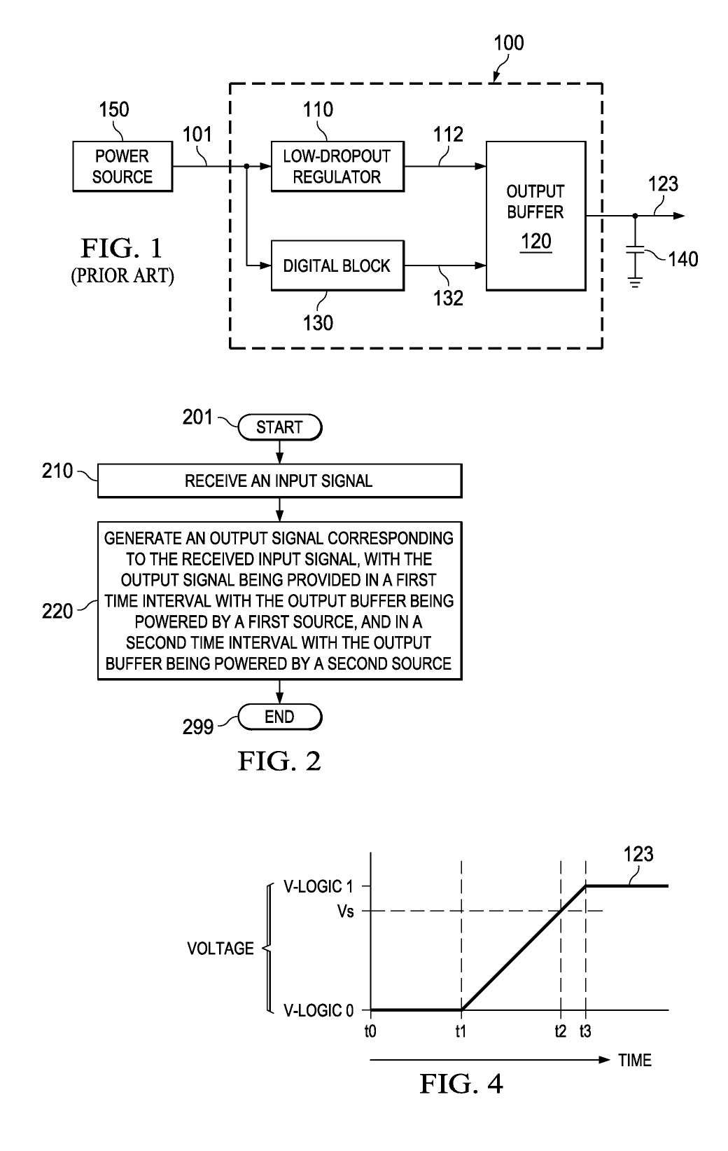

FIG. 1 is a block diagram of an example prior environment (device/system) which can be extended/modified according to several features of the present invention. The environment is shown containing IC 100, capacitor 140 and power source 150, with IC 100 containing low-drop out (LDO) regulator 110, output buffer 120, digital block 130, and capacitor 140. Although not shown, IC 100 (as well as the environment) may contain various components/blocks other than those shown in FIG. 1. Each block of FIG. 1 is described in detail below.

Power source 150 supplies a regulated voltage (referred to as power supply 101) on path 101 for the operation of IC 100. Though not shown, power source 150 may supply regulated voltages of other magnitudes suited for other components of the environment or within IC 100. Power supply 101 may be designed to supply large/sufficient current for the operation of all components in IC 100.

LDO 110 receives power supply 101, and generates a power supply on path 112. For example, power supply 101 may be 1.8V, and LDO 110 may generate 1.2V. As LDO 110 provides a power supply to output buffer 120, LDO 110 may also be termed as a power source.

Digital block 130 generates signals representing digital (binary) values on path 132. Digital block 130 receives power supply for operation via path 101. Alternatively, digital block 130 may also receive power supply from LDO 110, although not shown. Digital block 130 may correspond, for example, to a central processing unit, a digital logic block, or in general, any circuit block generating digital outputs.

Output buffer 120 receives digital (binary) values on path 132, and forwards the values on path 123 with increased drive. Path 123 may represent a conductive trace on a printed circuit board, and may be connected to another component receiving buffered output values provided by output buffer 120 on path 123. When the block diagram of FIG. 1 represents a device/system, output buffer 120 may be used to provide the values to external devices/systems. On the other hand, the output buffer 120 can be used to drive other components (e.g., integrated circuits) provided within the same system/device.

Capacitance of capacitor 140 represents the combined (lumped) capacitance exhibited by path 123. Capacitance of capacitor 140, in addition includes any on chip (within IC 100) capacitance, such as for example, at the output of pad (not shown) of output buffer 120, bonding wire from the pad to external pin (also not shown) but present on path 123.

As may be appreciated, when the output of output buffer 120 changes from a binary 0 to a binary 1, power supply 112 may need to charge capacitor 140, before the output value on path 123 reaches a voltage level corresponding to logic 1. Generally, larger the capacitance of capacitor 140, greater will be the amount of charge/current that needs to be supplied by power supply 112. Consequently, LDO 110 may need to be implemented consistent with such a requirement, and thus may have to be designed as a high-speed/high power (current) component.

Alternatively, a large value of decoupling capacitor (not shown) may need to be provided at the output of LDO 110 (path 112). However, provision of such a large value of capacitor on chip (within IC 100) may not be desirable due to increased area, cost, etc. One solution is to provide such a large valued decoupling capacitor external to IC 100, thereby requiring output 112 to be provided (brought-out) onto an external pin (not shown) of IC 100. Such a solution is also not desirable since it increases the pin-count requirement.

Several aspects of the present invention overcome one or more of the shortcomings noted above, as illustrated next with respect to a flowchart.

### 3. Using Multiple Power Supplies to Drive a Single Buffer Output

FIG. 2 is a flowchart illustrating the manner in which an output of an output buffer is generated using multiple power supplies in an embodiment of the present invention. The flowchart is described with respect to the components of FIG. 1 merely for illustration. However, various features described herein can be implemented in other environments, as will be apparent to one skilled in the relevant arts by reading the disclosure provided herein.

Furthermore, the steps are described in a specific sequence merely for illustration. Alternative embodiments in other environments, using other components, and different sequence of steps can also be implemented without departing from the scope and spirit of several aspects of the present invention, as will be apparent to one skilled in the relevant arts by reading the disclosure provided herein. The flowchart starts in step 201 in which control is transferred to step 210.

In step 210, output buffer 120 receives an input signal (path 132 in FIG. 1). Though the description is provided assuming that the input signal represents a digital value, it should be appreciated that alternative embodiments can be implemented when the input signal represents analog information as well. Control then passes to step 220.

In step 220, output buffer 120 generates an output signal (path 123) corresponding to the received input signal (path 132), with the output signal being provided in a first time interval with output buffer 120 being powered by a first source, and in a second time interval with the output buffer being powered by a second source. In other words, the first and second source provide the necessary power supply to drive the output of the output buffer in the respective time intervals. The flowchart ends in step 299.

The output signal generally needs to be of sufficient strength consistent with the requirement of the external load being driven in the embodiment of FIG. 1. However, the sources can be selected to meet the various requirements presented by the environment in which the method of FIG. 2 is implemented. It should be appreciated that though the examples here are described with respect to two sources, additional sources also can be employed, as suited for the specific environments.

The description is continued with respect to the manner in which the circuit of FIG. 1 can be extended/modified in accordance with at least some of the features of FIG. 2 to address at least one or more of the problems noted above with respect to FIG. 1.

### 5. Example Embodiment

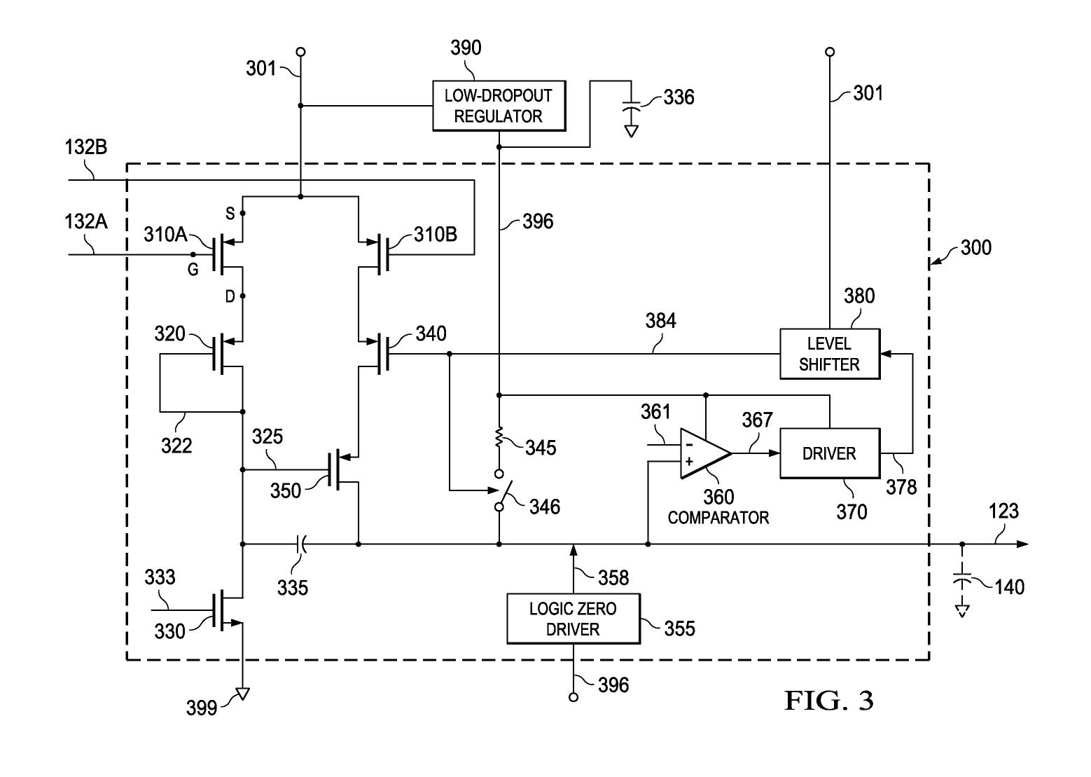

FIG. 3 is a diagram of an IC containing an output buffer operated using two power supplies, in an embodiment of the present invention. It must be understood that specific components and interconnections shown in the Figure are provided merely by way of illustration. Other embodiments using different components/architecture and/or interconnection may also be implemented without departing from the spirit and scope of several features of the present invention.

Similarly, the embodiment is described with respect to 1.2 Volts and 1.8 Volts as power supplies used for driving the output of output buffer. However, other magnitudes of voltage supplies can also be used in alternative embodiments, without departing from several aspects of the present invention.

Capacitance 140 in FIG. 3 represents the combined (lumped) capacitance on path 123, as noted above with respect to FIG. 1. Terminal 399 represents ground or a fixed reference potential. FIG. 3 is shown containing output buffer 300 and LDO 390, which are described in detail below.

LDO 390 receives input power (assumed 1.8V in this example) via path 301, and generates a 1.2V power supply on path 396. LDO 390 may thus be viewed as a source of power supply. Power supplies 301 and 396 may thus be considered as a ‘first’ and ‘second’ power supplies (power sources) respectively. LDO 390 may be implemented as a comparatively low-capacity, low-power device. Capacitor 336 is provided as a decoupling capacitance to supply transients drawn from 1.2V power supplied by LDO 390.

Output buffer 300 (corresponding portions of output buffer 300 as shown in FIG. 3) drives output 123 based on power supply received from power supply 301 and LDO 390, as described below in further detail.

Output buffer 300 is shown containing P-type Metal Oxide Semiconductor Field Effect Transistor (PMOS) 310A, 310B, 320, 340 and 350, N-type Metal Oxide Semiconductor Field Effect Transistor (NMOS) 330, logic zero driver 355, capacitors 335 and 336, switch 346, resistor 345, comparator 360, driver 370, and level shifter 380. The source, drain and gate terminals of PMOS 310A are marked in FIG. 3 as ‘S’, ‘D’, and ‘G’ respectively. Although similar markings are not provided for the other transistors, the corresponding terminals have similar meanings. The components/blocks of output buffer 300 are described in detail below. Switch 346 may be implemented using any of several well-known techniques, such as using transistors etc.

Comparator 360 receives voltage 123 on a non-inverting terminal, and reference voltage 361 (generated internally) on an inverting terminal, and operates to provide logic level output 367 as a comparison result (either 0V or 1.2V) of the two inputs. As will be clearer from the description below, the magnitude of the reference voltage determines the specific voltage level on output path 123 at which the switching to another power supply occurs. In an embodiment, the reference voltage on path 361 is approximately equal to 1.15V when the output path 123 needs to be driven to a voltage of 1.2 volts to represent logic 1.

Driver 370 receives the comparison result of comparator 360 on path 367, and provides a corresponding buffered (with greater drive) output (either 0V or 1.2V) on path 378 to level shifter 380. Each of comparator 360 and driver 370 receive 1.2V power for operation.

Level shifter 380 receives an input on path 378, and provides a corresponding level-shifted output on path 384 (connected to the gate terminal of PMOS 340). Level shifter 380 forwards a 0V (or equivalent logic low voltage) input as a corresponding 0V output on path 384, and forwards a 1.2V input as a 1.8V output on path 384. Level shifter 380 receives 1.8V power via path 301 for its operation.

Output buffer 300 receives input binary data on path 132A. Output buffer 300 also receives on path 132B the complementary (inverted) value of the data on path 132A. It is assumed in the following description that output buffer 300 provides a buffered output (non-inverted) of the received input data on path 132A.

In operation, when data on path 132A is a logic 0 (corresponding to a low voltage), complementary data on path 132B is a logic 1 (high voltage). As a result, PMOS 310B and 340 are in the off state, and output 123 is not driven/controlled by any of the transistors in FIG. 3, but instead by logic zero driver 355. It is noted that paths 132A and 132B are deemed to be present in path 132 of FIG. 1.

Logic zero driver 355 receives 1.2V via path 396, and operates to drive output 123 to logic zero (or logic low) via path 358, and may be implemented as an active or passive pull-down circuit to connect output 123 to ground (or logic zero voltage reference). Although noted as being implemented as a pull-down circuit, logic zero driver 355 may be implemented alternatively according one of several well-known techniques.

Since data on path 132A is at logic 0, PMOS 310A is on. Since PMOS 310A is on, PMOS 320 (which is connected to operate as a diode, since the gate terminal is tied to the drain terminal) is also on. NMOS 330 receives a bias voltage on gate terminal (333), and operates as a current source, with the current passed through NMOS 330 being based on the biasing voltage 333. In an embodiment, the current through NMOS 330 is 100 micro Amperes.

Thus, PMOS 320 (operating as a diode) is biased such that a small voltage is present at the gate of PMOS 350. In the embodiment, the voltage is equal to about 100 millivolts (mv) plus the threshold voltage Vt of PMOS 350, and thus pre-charges the gate of PMOS 350. Such pre-charging keeps PMOS 350 ready (biased) for the 0 to 1 transition operation, described below.

Thus, when data 132A is logic 0, output 123 is at logic 0. The outputs of comparator 360, buffer 370, and level shifter 380 are also logic 0. As a result, when data output 123 is 0 (or less than reference voltage 361), the output of level shifter 380 is a logic 0, and the gate of PMOS 340 is enabled, while switch 346 is open.

When data on path 132A transitions (or is at) to logic 1, complementary data on path 132B is at logic 0. As a result, PMOS 310A and PMOS 320 are off, while PMOS 310B is on. It may be noted that PMOS 340 is also on due to the previous value of output of level shifter 380, as described above.

Since the gate of PMOS 350 is pre-charged (as noted above), PMOS 350 is also on. Consequently, the path from power supply 301 through PMOS 310B, PMOS 340, and PMOS 350 is closed (completed), and the voltage at output 123 begins to rise towards 1.8V. If PMOS 350 is designed to have a large trans-conductance (gm), and since it has already been pre-charged to an appropriate biasing point (as described above), PMOS 350, capacitor 335 and NMOS 330 (acting like a current source) form a negative feedback circuit with the output 123 rising at a steady rate determined by the value of the current through NMOS 330 divided by the value of capacitor 335.

When the voltage on path 123 crosses reference voltage 361 (example value in the embodiment being 1.15V), output 367 of comparator 360 goes to logic high. Consequently, output 378 of driver 370 goes high, and level shifter 380 provides 1.8V on path 384.

Thus, when output 123 crosses reference 361, the resulting 1.8V output on path 384 switches off PMOS 340. Substantially simultaneously, output on path 384 closes switch 346. Thus, output 123 is driven by (or switched to) the 1.2V output of LDO 390.

It may be appreciated that PMOS 310A, 310B, 320, 340 and 350, NMOS 330, logic zero driver 355, capacitors 335 and 336 may together be viewed as a “signal generation circuit” which receives input signal 132A, and generates output 123 based on input signal 132A. Similarly, comparator 360, driver 370, level shifter 380, switch 346, and resistor 345 may together be viewed as a “control circuit” to cause the signal generation circuit to drive output 123 using power supply 301 in a first time interval, and using said power supply 396 in a second time interval.

The operation of output buffer 300 FIG. 3 described above is illustrated with the example timing diagram of FIG. 4. In the Figure it is assumed that V-logic 1 corresponds to the logic high condition, and equals 1.2V. V-logic 0 corresponds to the logic low condition and equals 0V.

With combined reference to FIGS. 3 and 4, when data 132A is logic 0, output 123 is also at logic 0, and is driven by power supply 301. With respect to the timing diagram of FIG. 4, the 1.2V supply (path 396) drives output 123 between intervals t0 and t1. As may be appreciated, t1 (or slightly before t1) may be viewed as a time instance at which the output voltage 123 is to be driven from voltage level V-logic 0 to V-logic 1.

When output 123 transitions from logic 0 to logic 1 (in response to data 132A changing from logic 0 to 1), output 123 is driven by the comparatively higher power (capacity) 1.8V supply between the interval t1 and t2. In the example provided with respect to FIG. 3, time instance t2 corresponds to the time when output 123 crosses 1.15V (reference 361), and voltage vs corresponds to 1.15V.

Output 123 is driven by the 1.2V supply again from time instance t2 onwards, and ramps up from 1.15V to 1.2V. Power supply 396 (1.2V) maintains output 123 at 1.2V till input data 132A changes back to zero.

It may be appreciated that the majority of the current required to accomplish the transition of output 123 from logic 0 to logic 1 (due to charging of capacitor 140, as noted above with respect to FIG. 1) is provided by the high capacity 1.8V power supply, rather than the low capacity 1.2V power supply. Power supply 396 (1.2V, i.e., the lower capacity power supply) now may need to supply charging current merely to raise output 123 from 1.15V to 1.2V. It may be appreciated that such charging current may be very small in magnitude, which may be supplied by the relatively small on-chip capacitor 336.

The 1.2V power supply may thus be designed as a low power/low capacity component. Further, the technique described above obviates the need for an external pin and external decoupling capacitor which might otherwise (or in the alternative) be required, as noted above with respect to FIG. 1.

Although output buffer 300 is shown to have the specific structure as shown in FIG. 3, it must be understood that various other structures/architectures may be used for output buffer 300 without departing from the scope and spirit of several features of the present invention. For example, output buffer 300 may be implemented as a simple CMOS buffer, well known in the relevant arts.

Thus, several aspects of the present invention provide an output buffer which operates in the presence of multiple power supplies. As noted above, the features can be adapted for different requirements, as suited in the specific environments. For example, though the description is provided with respect to only rising transitions, alternative embodiments can be implemented to use similar techniques for falling transitions as suited in the specific environments.

As yet another example, a more precise comparator can be used to bring the interval t2-t3 to 0 such that the higher voltage (1.8 Volts) power supply is used almost for the entire transition to 1.2 Volts, while the lower voltage (1.2 Volts) is thereafter used merely to maintain the output signal at the desired 1.2 V level.

It should be appreciated that the specific type of transistors (PMOS, NMOS, etc.) in the examples above are chosen merely for illustration. However, alternative embodiments using different configurations and transistors will be apparent to one skilled in the relevant arts by reading the disclosure provided herein. For example, the PMOS and NMOS transistors may be interchanged, while also interchanging the connections to power and ground terminals.

Accordingly, in the present application, ground terminals are referred to as reference potentials, the source and drain terminals (though which a current path is provided when turned on and a open path is provided when turned off) are termed as current terminals, and the gate terminal is termed as a control terminal. Furthermore, though the terminals are shown with direct connections to various other terminals, it should be appreciated that additional components (as suited for the specific environment) may also be present in the path, and accordingly the connections may be viewed being electrically coupled to the same connected terminals.

### 6. Conclusion

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A method of providing an output signal based on an input signal on an output path, said method being performed in an output buffer, said method comprising:
receiving said input signal; and
driving said output path using a first power supply in a first time interval and using a second power supply in a second time interval, while providing said output signal corresponding to said input signal on said output path.

2. The method of claim 1, wherein said input signal contains a transition from a first logic value to a second logic value, wherein said output signal is to change from a first voltage level to a second voltage level in response to said transition of said input signal,
wherein said first time duration and said second time duration are contained in a time duration after said output signal is to be driven to change from said first voltage level to said second voltage level.

3. The method of claim 2, wherein said second voltage is higher than said first voltage, wherein said second power supply supplies voltage equal to said second voltage level.

4. The method of claim 3, wherein said driving comprises:
comparing a voltage level on said output path with a reference voltage; and
switching from said first power supply to said second power supply when said voltage level crosses said reference voltage.

5. The method of claim 4, wherein said reference voltage is designed to be less than said second voltage level.

6. The method of claim 4, wherein said reference voltage is designed to equal said second voltage level.

7. A device comprising:
a first power supply;
a second power supply;
a digital block to generate an input signal containing a value; and
an output buffer providing an output signal on an output path based on said input signal wherein said output buffer is operable to drive said output path using said first power supply during a first duration and using said second power supply during a second duration,
wherein said first duration comprises a substantial part of a rising transition of said output signal.

8. The device of claim 7, wherein said output buffer comprises:
means for receiving said input signal; and
means for driving said output path using said first power supply in said first time interval and using said second power supply in said second time interval, while providing said output signal corresponding to said input signal on said output path.

9. The device of claim 8, wherein said means for driving is operable to:
compare a voltage level on said output path with a reference voltage; and
switch from said first power supply to said second power supply when said voltage level crosses said reference voltage.

10. An output buffer providing an output signal on an output path based on an input signal, said output buffer being designed to receive a first power supply and a second power supply, said output buffer comprising:
a signal generation circuit to receive said input signal, and to generate said output signal on said output path based on said input signal; and
a control circuit to cause said signal generation circuit to drive said output path using said first power supply in a first time interval, and using said second power supply in a second time interval, while generating said output signal based on said input signal.

11. The output buffer of claim 10, wherein said input signal contains a transition from a first logic value to a second logic value, wherein said signal generation circuit changes said output signal from a first voltage level to a second voltage level in response to said transition of said input signal,
wherein said control circuit causes said first time duration and said second time duration to be contained in a time duration after said output signal is to be driven to change from said first voltage level to said second voltage level.

12. The output buffer of claim 11, wherein said control circuit comprises:
a comparator comparing a voltage on said output path with a reference voltage, and providing a signal to cause said signal generator to drive said output path using said first power supply when a result of comparison is of one logic value and using said second power supply when said result is of the other logic value,
whereby said result is of said one logic value in said first duration and of said other logic value in said second duration.

13. The output buffer of claim 12, wherein said signal generation circuit comprises:
a first switch to couple said first power supply to said output path when said result is of said one logic value; and
a second switch to couple said second power supply to said output path when said result is of said other logic value.

14. The output buffer of claim 13, wherein said first switch is a first transistor having a control terminal coupled to receive an output of said comparator, said first transistor providing a conductive path between a pair of terminals when said control terminal receives said one logic value and a open path between said pair of terminals when said control terminal receives said other logic value, wherein one of said pair of terminals is coupled to said first power supply and the other one of said pair of terminals is coupled to said output path.

15. The output buffer of claim 14, wherein said signal generation circuit further comprises:
a diode;
a second transistor with a control terminal coupled to said input signal, a first current terminal of said second transistor coupled to said first power supply, a second current terminal of said second transistor coupled to a first terminal of said diode;
a third transistor with a control terminal coupled to a complement of said input signal, a first current terminal of said third transistor coupled to said first power supply, a second current terminal of said third transistor coupled to one of said pair of terminals of said first transistor;
a fourth transistor with a control terminal coupled to a second terminal of said diode, with a first current terminal of said fourth transistor coupled to the other one of said pair of terminals of said first transistor, a second current terminal of said fourth transistor coupled to said output path;
a first capacitor coupled between said second terminal of said diode and said second current terminal of said fourth transistor;
a current source coupled between said second terminal of said diode and a first reference potential;
a second capacitor coupled between said output path and said first reference potential; and
a logic driver block coupled to said output path and operating to pull said output path to said first voltage when said input signal is at said first logic value.

16. The output buffer of claim 15, wherein said reference voltage is designed to be less than said second voltage level.

17. The output buffer of claim 15, wherein said reference voltage is designed to equal said second voltage level.

18. The output buffer of claim 15, wherein said first power supply provides a voltage of 1.8 Volts and said second power supply provides a voltage of 1.2 volts.
